(19) United States
(12) Patent Application Publication
(10) Pub. No.: US 2026/0367913 A1
(43) Pub. Date: Nov. 19, 2026

(54) Data Hazard Detection and Resolution

(71) Applicant: MIPS Tech, LLC, San Jose, CA (US)

(72) Inventors: Abhishek Appu, El Dorado Hills, CA (US); Cristobal Ramirez Lazo, Austin, TX (US); Bradley Burgess, Sunset Valley, TX (US); Kathlene Magnus, San Antonio, TX (US); Corbin Bremmeyr, Hutto, TX (US)

(21) Appl. No.: 19/210,884

(22) Filed: May 16, 2025

(51) Int. Cl. G06F 9/30; G06F 9/38

(52) U.S. Cl. CPC G06F 9/30018; G06F 9/30036; G06F 9/30038; G06F 9/3838

(57) ABSTRACT

In one embodiment, a method includes determining, by a vector memory scoreboard, and for each of multiple instructions in a vector instruction queue, whether a hazard dependency exists for the instruction. The method further includes in response to a determination that one or more hazard dependencies exist for a first instruction, then determining, while the instruction is in the vector instruction queue and prior to executing the first instruction, based on the vector memory scoreboard, whether the hazard dependency has been resolved; and in response to a determination that the hazard dependency has been resolved, then transmitting, to a load/store unit, and prior to executing the first instruction, permission to perform a load or store operation for the first instruction

### TECHNICAL FIELD

This application generally relates to data hazard detection and resolution.

### BACKGROUND

Data hazards occur when two or more processor instructions perform load or store operations on the same register space and the sequence of operations affects the outcome of one or more of those operations. Data hazards include write-after-write (waw) hazards, in which two instructions write to the same register space; write-after-read (war) hazards, in which one instruction should write to a register space after another instruction reads from that space; and read-after-write (raw) hazards, in which one instruction should read from a register space after another instruction writes to that space. The order of instruction operations is critically important in data hazards. For example, for raw hazards one instruction must read from a register after a different instruction has written to that register, and therefore the reading instruction will return erroneous data if the read occurs first or if another instruction writes to the register space before the read occurs.

The waw and war hazards are sometimes referred to as anti-dependencies because the subsequent write does not depend the preceding write or read, respectively, although the first write or read must occur prior to the subsequent write in order for those initial operations to result in the correct operation. The raw hazards are sometimes referred to as true dependencies because the subsequent read does depend on the preceding write.

### BRIEF DESCRIPTION OF THE DRAWINGS

FIG. 1 illustrates an example method for efficient data hazard detection and resolution.

FIGS. 2A-2C illustrate an example implementation of certain features of the example method of FIG. 1.

FIGS. 3A-3C illustrate an example detection logic for determining data hazards for queued instructions.

### DESCRIPTION OF EXAMPLE EMBODIMENTS

Out-of-order processors deal with data hazards by using a large register space to support many (e.g., hundreds) of renamed registers. These renamed registers become a temporary register space on which operations can be performed, so that conflicting instructions avoid using the exact same register space. Instructions can also be selected for execution in an order that does not create data hazards. However, renamed registers spaces and out-of-order schemes are complex and resource-intensive, and therefore are typically only employed for processor cores in which area and power are not a concern.

In contrast, data hazards make it difficult to achieve high performance on cores for which area or power are a concern, e.g., for which resource-intensive renaming logic or the complexity of an out-of-order scheme are not attractive solutions. For in-order schemes, the typical approach is to maintain a scoreboard that keeps track of which registers are currently being used by instructions that are executing on the processor pipeline. If a load/store instruction is ready for issue but would use a register identified as in use by an executing instruction, then that load/store instruction must wait to perform its operations until the in-use register identified by the scoreboard becomes available. In other words, the processor must stall execution of the load/store instruction.

This stall decreases the processor's throughput, because the load/store instruction's operations will have some latency prior to using the identified registers. For instance, an instruction that loads some data from computer memory (e.g., from the processor's L1 cache, L2 cache, or beyond) must wait for the data to be fetched and returned before the instruction can fully execute. Therefore, latencies in stalling due to data hazards will accumulate with latencies due to load/store operations, reducing throughput.

In contrast, the techniques of this disclosure can begin performing load and/or store operations before the instruction executes, i.e., while the instruction is still in the queue, even when a potential data hazard is present. As explained below, particular embodiments of this disclosure perform these load/store operations in parallel, even while waiting for a data hazard to resolve, effectively hiding latencies and increasing processor throughput without requiring the resources and complexity of register renaming or out-of-order processing. In addition, particular embodiments of this disclosure determine which instruction(s) in a queue have no data hazard or have a resolved data hazard, allowing those instructions' load/store operations to be initiated while the instruction is still in the queue.

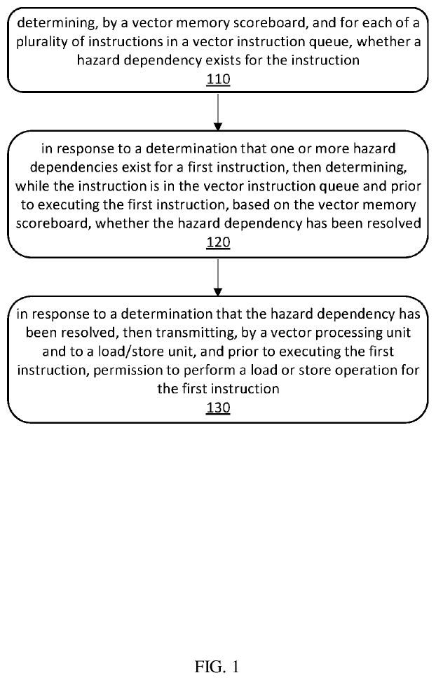

FIG. 1 illustrates an example method for efficient data hazard detection and resolution. While the example of FIG. 1 references vector-based operations and vector processors, this disclosure contemplate that these techniques may likewise be applied to scalar-based operations and processors.

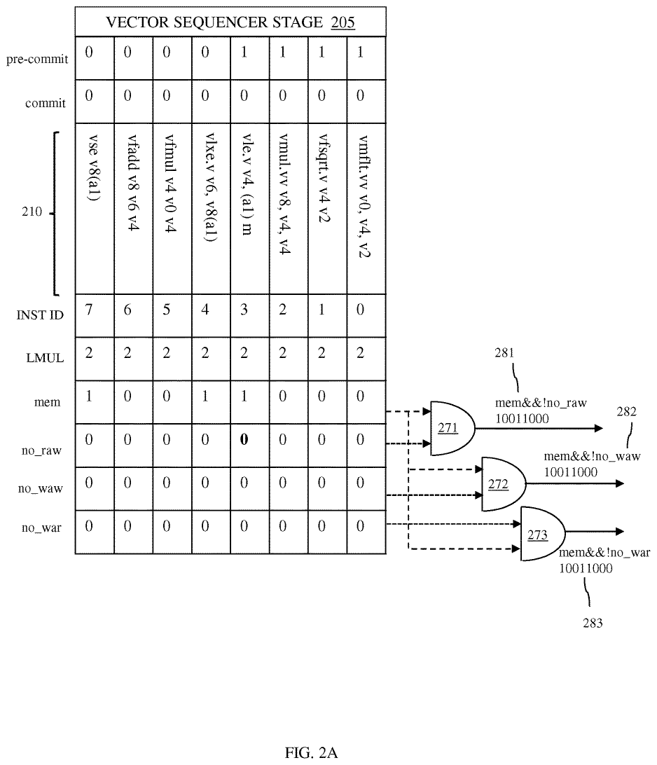

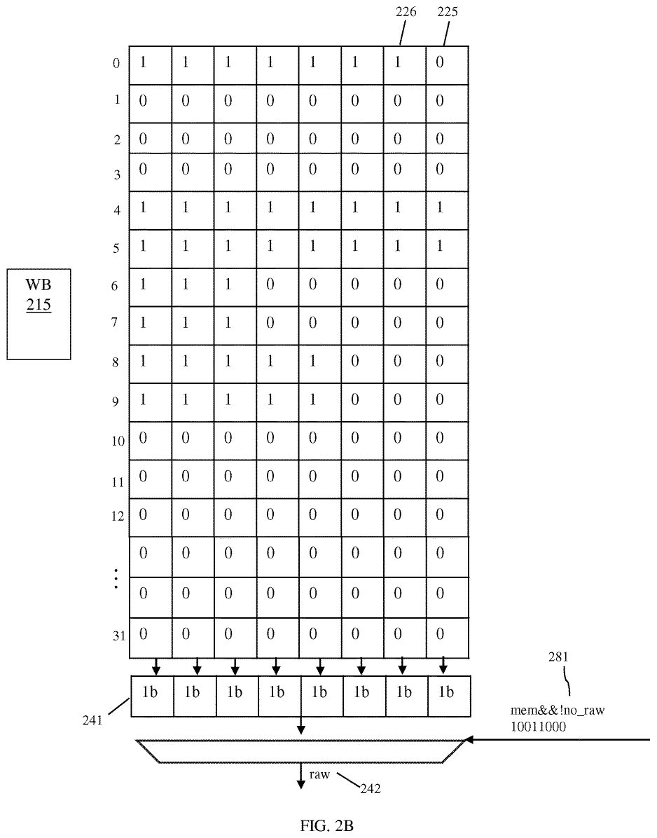

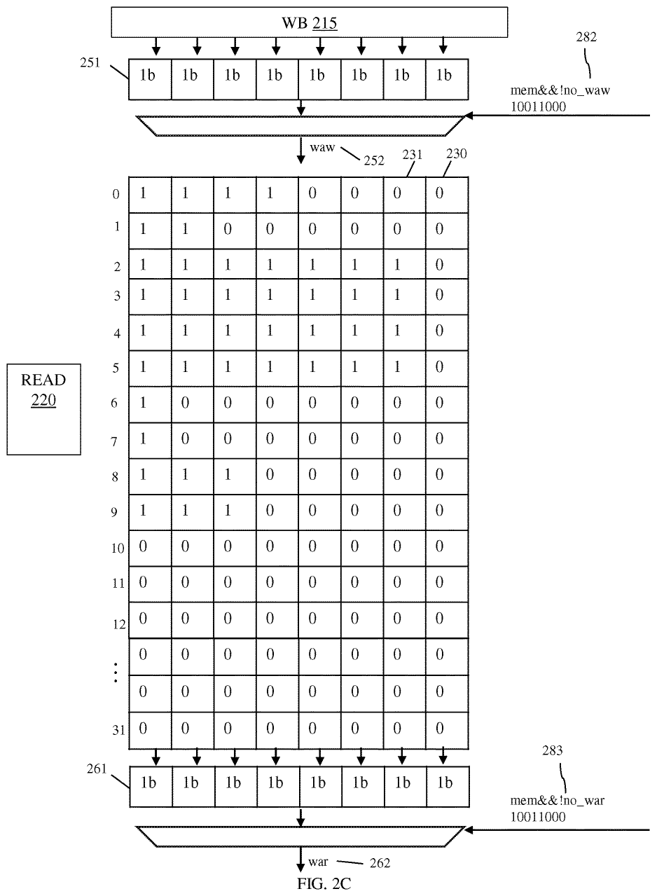

Step 110 of the example method of FIG. 1 includes determining, by a vector memory scoreboard, and for each of multiple instructions in a vector instruction queue, whether a hazard dependency exists for the instruction. FIGS. 2A-2C illustrate an example implementation of these features. The example of FIGS. 2A-2C illustrate a vector sequencer stage 205 that includes an instruction queue 210. In the example of FIGS. 2A-2C, queue 210 is 8 instructions deep, although this disclosure contemplates that a queue of any size may be used. In the example of FIGS. 2A-2C instructions move from left to right, such that the oldest instruction issued into the queue takes the rightmost place in the queue, and the newest instruction takes the leftmost place in the queue. In particular embodiments, if an instruction issues from the queue to the execution unit, then the remaining queued instructions are shifted right, such that a new instruction is always placed in the leftmost position of the queue.

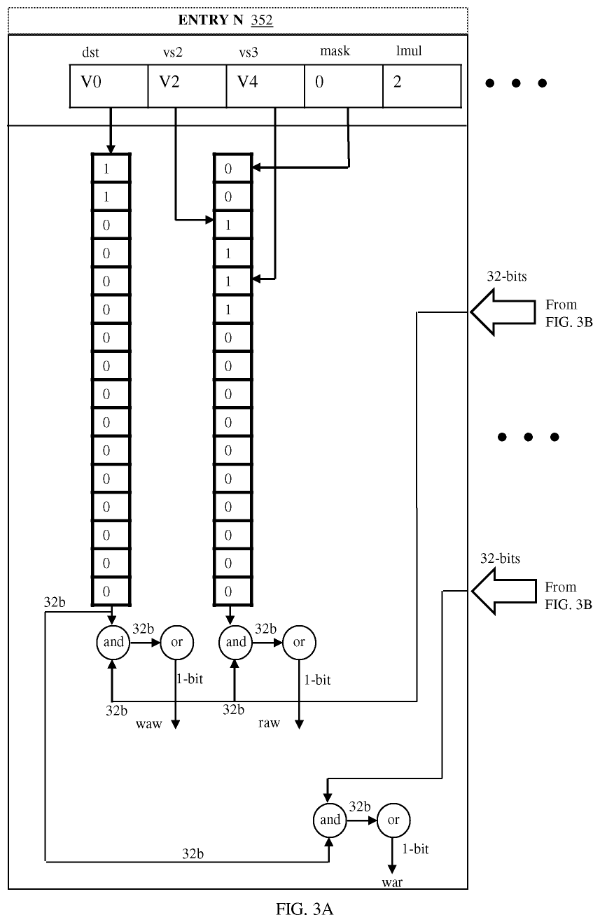

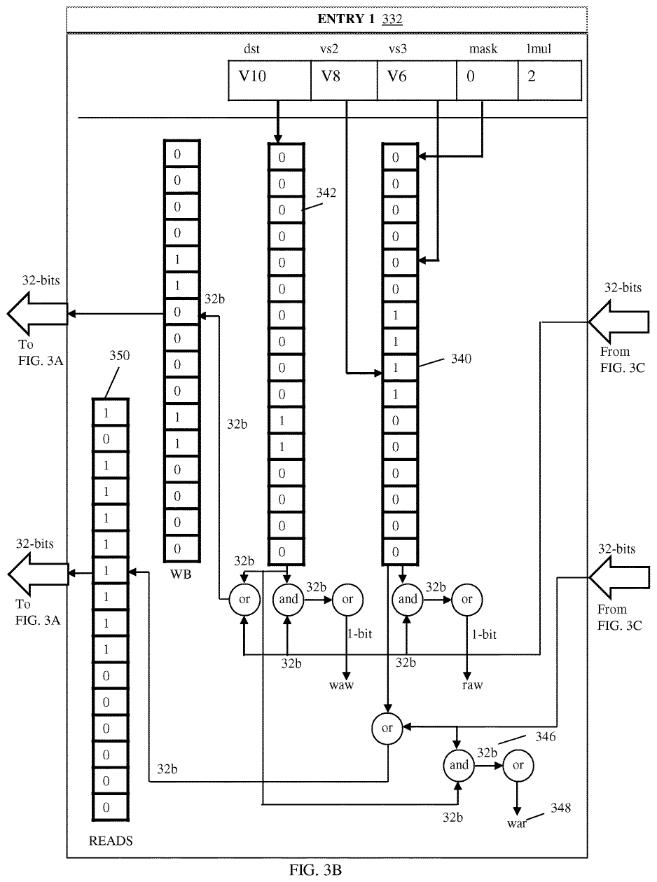

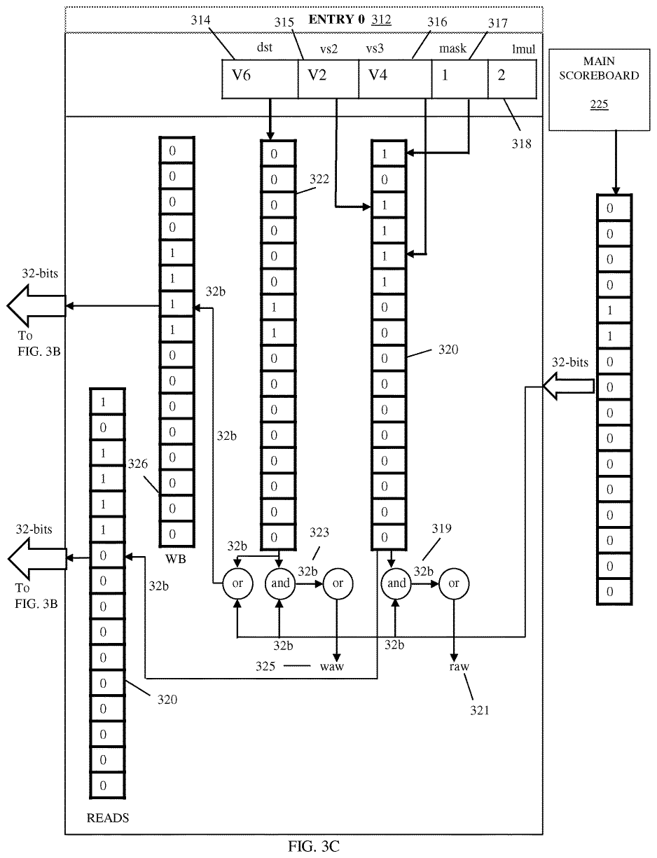

The execution engine (not shown) of the processor is executing instructions that have passed through the queue, and an issue scoreboard (or main scoreboard), e.g., as illustrated in FIGS. 3A-3C and discussed more fully below, identifies which registers of the microarchitecture are in use by the executing instruction(s). For instance, in the example of FIG. 3A-3C, a “1” in a bit field of main scoreboard 225 means that the corresponding register is currently being used by an executing instruction, and this main scoreboard is updated at the vector issue stage when an instruction is issued into the execution pipeline. In particular embodiments, the instructions in queue 210 may be from a RISC-V instruction set, although this disclosure contemplates that other architectures may be used.

Along with vector queue 210, vector sequencer stage 205 includes a number of bit fields that are used by the techniques described herein. An instruction ID field (“INST ID” in the example of FIGS. 2A-2C) is an index that is used to identify the instructions. An “LMUL” field essentially identifies how many operations each instruction is broken into when executed, e.g., after passing through a sequencer stage. The LMUL field also identifies how many registers will be occupied by source or destination operands of the instructions. For example, as described more fully below, the examples of FIGS. 2A-2C and 3A-3C correspond to a microarchitecture that has 32 registers. An LMUL of 2, as is illustrated in the example of FIGS. 2A-2C, means that each operand will occupy 2 registers, e.g., if an operand identifies register 5, then both register 5 and register 6 are implicated by the operand.

In the example of FIGS. 2A-2C, the “mem” field identifies whether an instruction is a load/store (LS) instruction. For instance, a “1” in this field means that the corresponding instruction is a LS instruction, while a “0” means that the instruction is not a LS instruction (e.g., is an instruction that only uses the arithmetic logic unit). This bit is set based on, e.g., the opcode of the instruction, which identifies the operation to be performed by the instruction. The use of this bit is described more fully below.

In the example of FIGS. 2A-2C, each instruction has an associated “no_raw” (or “!raw”), “no_waw”, and “no_war” bit. In particular embodiments these bits are initially set to “0” when an instruction issues into the queue, and these bit values are updated during processor cycles as described below.

The example of FIGS. 2A-2C also includes a “pre-commit” bit and a “commit” bit. The “pre-commit” bit indicates that no older instruction can flush or fault, and this instruction is guaranteed to reach the retire point. This instruction may still fault, fault mid instruction, or cause a flush. The “commit” bit indicates that this instruction will not cause a flush or fault. The subsequent instruction can now “reach commit”. If an instruction is incapable of faulting (e.g., arithmetic) then the instruction may directly go to the committed state.

In the example of FIGS. 2A-2C, the vector memory scoreboard includes writeback (WB) table 215 and READ table 220. As explained above, the example of FIGS. 2A-2C illustrate an embodiment in which the microarchitecture has 32 registers, and therefore WB table 215 and READ table 220 each include 32 bits, one for each register indexed by bit IDs 0-31.

WB table 215 and READ table 220 are generated by the example detection logic of FIGS. 3A-3C. In particular embodiments, the detection logic of FIGS. 3A-3C is combinational circuitry that is always automatically performing the detection operations described herein, i.e., its outputs depend solely on the inputs, and not on, e.g., particular processor cycles or other timing inputs.

In the example of FIGS. 3A-3C, entry 312 corresponds to an instruction in queue 210 indexed by INST ID “0”. Likewise, entry 332 corresponds to an instruction indexed by INST ID “1”, and entry N 352 corresponds to an instruction indexed instruction ID N-1, e.g., in the example of FIGS. 2A-2C, N-1 is 7.

It is important to note that the actual example instructions in queue 210 are not identical to the example instructions in FIGS. 3A-3C, i.e., the instruction corresponding to entry 312 in FIGS. 3A-3C is not the same as the instruction identified by INST ID 0 in FIGS. 2A-2C. While these instructions differ for the purposes of explanation in this disclosure, in practice the instructions would be the same, as the detection logic operates on the instructions in the instruction queue.

To create a WB table (e.g., WB table 215), the detection logic inputs the main scoreboard (e.g., scoreboard 225, which is updated during instruction issuance to the execution stage) to the detection logic operating on entry 312. As illustrated in the example of FIGS. 3A-3C, the detection logic will determine the value of a waw hazard bit (e.g., bit 325) and a raw hazard bit (e.g., bit 321) for every instruction in the queue. The logic will also determine the value of a war hazard bit (e.g., bit 348) for every instruction in the queue except for the oldest instruction indexed by INST ID “0”. The raw hazard bits determined by the detection logic correspond to raw bits 241 in the example of FIGS. 2A-2C, the waw hazard bits determined by the detection logic correspond to waw bits 251 in the example of FIGS. 2A-2C, and the raw hazard bits determined by the detection logic correspond to waw bits 261 in the example of FIGS. 2A-2C. The use of these bits values are described below.

FIGS. 3A-3C illustrate an example of the detection logic that determines these data-hazard bit values. For the first instruction, i.e., entry 312 corresponding to the oldest instruction, the raw bit is determined as follows. First, a source vector 320 is created based on the source data for the instruction corresponding to entry 312. In the example of FIGS. 3A-3C, source vector 320 is determined as follows. Mask 317 is set to 1, and therefore the first bit in source vector 320 is set to 1 (even though LMUL is set to 2, the mask always implicates only a single bit). Source operand 315 identifies register v2 (i.e., register 2) and source operand 316 identifies register 4. Since lmul 318 is set to “2”, the source operands of entry 312 implicate the second and third registers and the fourth and fifth registers, respectively. Thus, the bits in source vector 320 corresponding to those registers are set to “1,” while the remaining bits are set to “0.”

Source vector 320 is then bitwise AND'd with scoreboard 225, such that a bit in source vector 320 is AND'd with the corresponding bit at the same location in scoreboard 225 (i.e., bit location 0 of vector 320 is AND'd with bit location 0 of main scoreboard 225, and so on) to create another 32-bit vector 319. The bits in vector 319 are then OR'd with each other—such that a “1” in any position in vector 319 results in a value of “1,” while a 0 in every position in string 319 results in a value of “0”—t determine the value of the single raw bit 321. This value corresponds to the rightmost bit of raw bits 241 in FIGS. 2A-2C.

For the first instruction, the waw bit is determined as follows. First, a destination vector 322 is created based on the destination operand(s) for the instruction corresponding to entry 312. In the example of FIGS. 3A-3C, destination vector 322 is determined as follows. Destination operand 314 identifies register 6, and since lmul 318 is set to “2”, destination operand 314 implicates the sixth and seventh registers, and therefore these bit positions are set to “1” in destination vector 322. Destination vector 322 is then bitwise AND'd with scoreboard 225 to create another 32-bit vector 323. The bits in this vector 323 are then OR'd with each other to determine the value of the single waw bit 325. This value corresponds to the rightmost bit of waw bits 251 in FIGS. 2A-2C.

To determine the waw hazard bit value and the raw hazard bit value for the next instruction (i.e., the instruction corresponding to entry 332, indexed by INST ID “1”), the input is not scoreboard 225, but is rather WB input vector 326. Vector 326 is created by bitwise OR'ing scoreboard 225 with destination vector 322. This vector is then used as input for entry 332 to determine the raw bit value for that instruction (based on WB input vector 326 and on entry 332's source vector 340) and used as input for entry 332 to determine the waw bit value for its instruction (based on vector 326 and entry's 332's destination vector 342). The AND'ing and OR'ing operations between the input vector and the entry's source and destination vectors follow the description above, as illustrated in FIGS. 3A-3C.

WB input vector 326 also corresponds to WB table 215. Specifically, the rightmost entry in WB table 215 is scoreboard vector 225. WB vector 326 corresponds to the entry immediately to the left in WB table 215, i.e., input vector 326 corresponds to vector 226 (although as described above, the specific bit values illustrated in vector 226 do not correspond to the bit values illustrated in vector 326, because different instructions are illustrated in FIGS. 2A-2C and FIGS. 3A-3C). In the example detection logic of FIGS. 3A-3C, each entry's WB vector is used as input to the following entry to determine waw and raw hazard bit values for that entry, and also corresponds to the respective entry in WB table 215. The only exception is for the last entry (e.g., entry 352) that corresponds to the newest instruction in the queue; this entry does not generate a WB vector, as is illustrated in FIGS. 3A-3C.

In particular embodiments, WB table 215 is not a separate entity from the respective WB vectors in the detection logic of FIGS. 3A-3C, i.e., WB table 215 simply illustrates the values of the WB vectors generated by the detection logic FIGS. 3A-3C.

FIGS. 3A-3C illustrate example detection logic for determining the war bit values corresponding to war bit values 261 in FIGS. 2A-2C. The first entry (i.e., entry 312) generates war bit 304, based on a bitwise AND between input vector 302 (which is a vector whose bits identify the register(s), if any, that the instruction(s) currently at the issue stage will read from) and destination vector 322 of entry 0 312. The resulting 32-bit vector 306 is then bitwise OR'd to obtain war bit value 304 for entry 0 312. Thus, the rightmost bit position in war bit values 261 is set by war bit 304. For the subsequent entries, the war bit values are determined as follows. First, source vector 320 for the first entry (entry 312) is bitwise OR'd with vector 302 to create read vector 327, which is used as input to entry 332. To determine the war bit value 348 for entry 332, vector 327 is bitwise AND'd with destination vector 342 of entry 332. The bits of the resulting 32-bit vector 346 are then OR'd to generate the war bit value 348 for the instruction corresponding to entry 332.

To generate the next READ vector that will be input to the next entry to determine the next instruction's war value, the read vector input to an entry is bitwise OR'd with that entry's source vector. For instance, input vector 327 to entry 332 is OR'd with entry 332's source vector 340 to generate read vector 350, which is used as the next input read vector for the next entry. This process is repeated until the final war bit value is determined, e.g., for entry 352.

READ table 220 corresponds to the read vectors generated in FIGS. 3A-3C. The first read vector 230 in READ table 220 corresponds to vector 302, which identifies the register(s), if any, that the instruction(s) currently at the issue stage will read from. Read vector 327 of entry 312 corresponds to the position of entry 231 in READ table 220, and each entry's read vector generated by the detection logic corresponds to the next position in READ table 220. As mentioned above for WB table 215, in particular embodiments READ table 220 is not stored separately from the READ vectors generated by the detection logic of FIGS. 3A-3C.

To summarize, FIGS. 2A-2C and 3A-3C illustrate an example embodiment in which the vector memory scoreboard includes a WB table and READ table. This example embodiment determines a raw hazard, a waw hazard, and a war hazard for each instruction in a queue, and the presence of these hazards are reflected in the bit values of raw bits 241, waw bits 251, and war bits 261, respectively.

Step 120 of the example method of FIG. 1 includes, in response to a determination that one or more hazard dependencies exist for a first instruction, then determining, while the instruction is in the vector instruction queue and prior to executing the first instruction, based on the vector memory scoreboard, whether the hazard dependency has been resolved.

FIGS. 2A-2C illustrate an example of determining whether hazard dependencies for instructions in queue 210 have been resolved. The example of FIGS. 2A-2C uses combinational logic 271, 272, and 273. Specifically, logic 271 performs a bitwise AND operation between the “mem” vector and a NOT of the “no_raw” vector to generate, in the example of FIGS. 2A-2C, an 8-bit vector 281. As described above, the “no_raw” bits are each initially set to “0,” so given the bits in the “mem” field in the example of FIGS. 2A-2C, vector 281 is “10011000”. Vector 281 is then used to select a specific raw value from raw bits 241. Specifically, the raw bit in raw bits 241 corresponding to the rightmost “1” of vector 281 is selected and output as the value of raw bit 242. In this example, the rightmost “1” of vector 281 corresponds to the 4^{th} oldest instruction, i.e., INST ID 3, and therefore the value of the raw bit for this instruction as determined by the detection logic of FIGS. 3A-3C is selected and output as the value of raw bit 242.

The value of this bit is then used to update the value of the corresponding “no_raw” bit in the next processor cycle. In other words, in the next processor cycle, the value of the “no_raw” bit for INST ID 3 (highlighted using bold font in FIG. 2A) is set to “1.”

Combinational logic 272 and 273 operate in a similar fashion, in that logic 272 performs a bitwise AND between the “mem” vector and a NOT of the “no_waw” vector to generate 8-bit vector 282, and logic 273 performs a bitwise AND between the “mem” vector and a NOT of the “no_war” vector to generate 8-bit vector 283. Vector 282 is then used to select a specific waw value from waw bits 251, and vector 283 is then used to select a specific war value from war bits 261, using the rightmost “1” in those respective vectors.

The value of bits 252 and 262 are then used to update the value of the corresponding “no_waw” and “no_war” bits, respectively, in the next processor cycle.

At this point, vector sequencer stage 205 can then take action on resolved hazards for the instructions in queue 210. For instance, if an AND between the “pre-commit” and the “no_raw” fields for a given instruction is “1,” then this means that the vector processor unit (VPU) can notify the LS unit that it can start reading the vector sources for that instruction, for example to start translation lookaside buffer (TLB) translations. As another example, if the AND of “pre-commit”, “no_war”, and “no_waw” bits for a given instruction is “1,” then this means that the VPU can grant writeback permissions to the LS unit for that instruction.

In particular embodiments, even if unresolved data hazards exist for a LS instruction, then certain operations can be initiated for those instructions, thereby reducing latencies. For instance, the detection logic can identify the data hazard as an anti-dependency. In these instances, the instructions load operations can be initiated, thereby preventing a stall that would occur when this instruction reaches issuance. If the loaded data is returned before the anti-dependency is resolved, then the instructions operations can be performed on the loaded data, and the result can be stored in a buffer of the LS unit. Once available, the result of the operation may be moved from the LS buffer to the destination register. This process reduces the latency associated with a data hazard, because loading data from the LS buffer to the register is much faster than initiating the load process once the register is available, performing operations on the loaded data, and writing the result to the destination register. For example, a load may require accessing the L1 cache or beyond, which can take several cycles to accomplish. As another example, an instruction may load data from a register and then perform complex operations (e.g., division) on those loads, which can take several processor cycles, and these operations can be performed even if an unresolved anti-dependency is present through use of the LS unit's cache. Moreover, the load buffer is significantly less resource-intensive than growing the register space, as registers have many read and write ports, whereas the load assembly buffer has just one write and one read port.

In particular embodiments, if an anti-dependency is resolved while an instruction's load or subsequent operations is in progress, then the result may be sent directly to the register, bypassing the LS unit's buffer. This process likewise improves throughput, as the load process and subsequent operations were initiated prior to data hazard becoming resolved, without needing to wait for a register to free up in the main vector scoreboard. In contrast, without these techniques, the processor will stall these load operations and subsequent processing until the data hazard is resolved.

Thus, as explained above, particular embodiments may reduce latency due to waw and war hazards, while waiting only for true dependencies to resolve before initiating a MEM instruction's load processes. In addition, embodiments the techniques described herein track when these dependencies are resolved, permitting a queued instruction's load processes to occur prior to execution, in the next cycle after hazard resolution.

Step 130 of the example method of FIG. 1 includes in response to a determination that the hazard dependency has been resolved, then transmitting, to a load/store unit, and prior to executing the first instruction, permission to perform a load or store operation for the first instruction. For example, the notification may be for the LS unit to start reading sources to start a TLB translation, or may be a grant of WB permissions to the LS unit for the instruction. Beginning these process as soon as data hazards are resolved allows latencies associated with these processes to occur prior to the instruction's placement in the execution pipeline, thereby effectively hiding this latency.

In particular embodiments, if all data dependencies are resolved for a memory instruction (i.e., the instruction's destination and source registers are available), then the instruction can be removed from the instruction queue and placed into execution.

In particular embodiments, once an instruction in the queue begins its load or store processes via a notification of permissions to the LS unit, then the corresponding registers may be identified as in-use on the main scoreboard. However, in particular embodiments this update is not necessary, e.g., because as in the example of FIGS. 2A-2C and 3A-3C, any newer instruction's dependency on those registers will be identified and tracked by the combinational hazard detection logic.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

1. A method comprising:
determining, by a vector memory scoreboard, and for each instruction of a plurality of instructions in a vector instruction queue, whether a hazard dependency exists for the instruction, wherein existence of any of multiple different types of hazard dependencies for the instruction is indicated by values of bits associated with the different types of hazard dependencies for the instruction, and wherein the values of bits associated with the different types of hazard dependencies for the instruction are determined based in part on a position of the instruction within the vector instruction queue;
in response to a determination that one or more hazard dependencies exist for a first instruction, then determining, while the first instruction is in the vector instruction queue and prior to executing the first instruction, based on the vector memory scoreboard, whether the hazard dependency has been resolved; and
in response to a determination that the hazard dependency has been resolved, then transmitting, to a load/store unit, and prior to executing the first instruction, permission to perform a load or store operation for the first instruction.

2. The method of claim 1, further comprising:
in response to a determination that one or more hazard dependencies exist for a second instruction, then determining, while the second instruction is in the vector instruction queue and prior to executing the second instruction, based on the vector memory scoreboard, whether the hazard dependency has been resolved; and
in response to a determination that the hazard dependency has not been resolved, then when the hazard dependency is an anti-dependency, initiating a load operation of the second instruction.

3. The method of claim 2, further comprising when the load operation completes before the anti-dependency has been resolved, then storing a result of the load operation in a buffer of the load/store unit.

4. The method of claim 2, further comprising when the load operation completes after the anti-dependency has been resolved, then storing a result of the load operation in a register identified by the second instruction.

5. The method of claim 1, wherein the vector memory scoreboard comprises combinational logic circuitry.

6. The method of claim 5, further comprising determining, by the vector memory scoreboard, a value of a read-after-write (raw) hazard bit for each of the plurality of instructions in the vector instruction queue, comprising:
for an oldest instruction in the queue, determining a value of a raw bit based on (1) an input writeback vector comprising a main scoreboard and (2) a source vector for the oldest instruction; and
for each subsequent instruction in the queue, determining a value of a raw bit based on (1) a writeback vector from a previous instruction, wherein the writeback vector from the previous instruction is based on (i) a writeback vector input to that previous instruction and (ii) a destination vector for that previous instruction, and (2) a source vector for the subsequent instruction.

7. The method of claim 5, further comprising determining, by the vector memory scoreboard, a value of a write-after-write (waw) hazard bit for each of the plurality of instructions in the vector instruction queue, comprising:
for an oldest instruction in the queue, determining a value of a waw bit based on (1) an input writeback vector comprising a main scoreboard and (2) a destination vector for the oldest instruction; and
for each subsequent instruction in the queue, determining a value of a waw bit based on (1) a writeback vector from a previous instruction, wherein the writeback vector from the previous instruction is based on (i) a writeback vector input to that previous instruction and (ii) a destination vector for that previous instruction, and (2) a destination vector for the subsequent instruction.

8. The method of claim 5, further comprising determining, by the vector memory scoreboard, a value of a write-after-read (war) hazard bit for each of the plurality of instructions in the vector instruction queue, comprising:
for an oldest instruction in the queue, determining a value of a war bit based on (1) an initial read vector identifying any registers that will be read by one or more instructions at an issuance stage and (2) a destination vector for the oldest instruction-; and
for each subsequent instruction in the queue, determining a value of a war bit based on (1) a read vector from a previous instruction and (2) a destination vector for the subsequent instruction.

9. The method of claim 8, wherein:
when the previous instruction is the oldest instruction in the queue, then the read vector from the previous instruction is based on (1) a source vector from the oldest instruction and (2) the initial read vector input to the oldest instruction; and
when the previous instruction is not the oldest instruction in the queue, then the read vector is based on (1) a source vector from the previous instruction and (2) a read vector input to the previous instruction.

10. A computer microarchitecture circuitry comprising:
combinational logic circuitry configured to:
determine, for each of a plurality of instructions in a vector instruction queue, whether a hazard dependency exists for the instruction, wherein existence of any of multiple different types of hazard dependencies for the instruction is indicated by values of bits associated with the different types of hazard dependencies for the instruction, and wherein the values of bits associated with the different types of hazard dependencies for the instruction are determined based in part on a position of the instruction within the vector instruction queue; and
when one or more hazard dependencies exist for a first instruction then determine, while the first instruction is in the vector instruction queue and prior to the first instruction being executed, whether the hazard dependency has been resolved; and
circuitry configured to transmit, in response to a determination by the combinational logic that the hazard dependency has been resolved and prior to the first instruction's execution, permission to a load/store unit to perform a load or store operation for the first instruction.

11. The microarchitecture circuitry of claim 10, wherein:
the combinational logic circuitry is further configured to determine, when one or more hazard dependencies exist for a second instruction and while the second instruction is in the vector instruction queue and prior to the second instruction's execution, whether the hazard dependency has been resolved; and
the microarchitecture circuitry further comprises circuitry configured to initiate, when the hazard dependency is an anti-dependency, a load operation of the second instruction by the load/store unit.

12. The microarchitecture circuitry of claim 11, further comprising circuitry configured to store a result of the load operation in a buffer of the load/store unit when the load operation completes before the anti-dependency has been resolved.

13. The microarchitecture circuitry of claim 11, further comprising circuitry configured to store a result of the load operation in a register identified by the second instruction when the load operation completes after the anti-dependency has been resolved.

14. The microarchitecture circuitry of claim 10, wherein the combinational logic circuitry is further configured to determine a value of a read-after-write (raw) hazard bit for each of the plurality of instructions in the vector instruction queue, by:
for an oldest instruction in the queue, determining a value of a bit based on (1) an input writeback vector comprising a main scoreboard and (2) a source vector for the oldest instruction; and
for each subsequent instruction in the queue, determining a value of a raw bit based on (1) a writeback vector from a previous instruction, wherein the writeback vector from the previous instruction is based on (i) a writeback vector input to that previous instruction and (ii) a destination vector for that previous instruction, and (2) a source vector for the subsequent instruction.

15. The microarchitecture circuitry of claim 10, wherein the combinational logic circuitry is further configured to determine a value of a write-after-write (waw) hazard bit for each of the plurality of instructions in the vector instruction queue, by:
for an oldest instruction in the queue, determining a value of a waw bit based on (1) an input writeback vector comprising a main scoreboard and (2) a destination vector for the oldest instruction; and
for each subsequent instruction in the queue, determining a value of a waw bit based on (1) a writeback vector from a previous instruction, wherein the writeback vector from the previous instruction is based on (i) a writeback vector input to that previous instruction and (ii) a destination vector for that previous instruction, and (2) a destination vector for the subsequent instruction.

16. The microarchitecture circuitry of claim 10, wherein the combinational logic circuitry is further configured to determine a value of a write-after-read (war) hazard bit for each of the plurality of instructions in the vector instruction queue, by:
for an oldest instruction in the queue, determining a value of a war bit based on (1) an initial read vector identifying any registers that will be read by one or more instructions at an issuance stage and (2) a destination vector for the oldest instruction; and
for each subsequent instruction in the queue, determining a value of a war bit based on (1) a read vector from a previous instruction and (2) a destination vector for the subsequent instruction.

17. The microarchitecture circuitry of claim 16, wherein:
when the previous instruction is the oldest instruction in the queue, then the read vector from the previous instruction is based on (1) a source vector from the oldest instruction and (2) the initial read vector input to the oldest instruction; and
when the previous instruction is not the oldest instruction in the queue, then the read vector is based on (1) a source vector from the previous instruction and (2) a read vector input to the previous instruction.

18. A method comprising:
determining, by a vector memory scoreboard, and for each of a plurality of instructions in a vector instruction queue, whether a hazard dependency exists for the instruction, wherein the vector memory scoreboard comprises combinational logic circuitry;
in response to a determination that one or more hazard dependencies exist for a first instruction, then determining, while the first instruction is in the vector instruction queue and prior to executing the first instruction, based on the vector memory scoreboard, whether the hazard dependency has been resolved;
in response to a determination that the hazard dependency has been resolved, then transmitting, to a load/store unit, and prior to executing the first instruction, permission to perform a load or store operation for the first instruction; and
determining, by the vector memory scoreboard, a value of a read-after-write (raw) hazard bit for each of the plurality of instructions in the vector instruction queue, comprising:
for an oldest instruction in the queue, determining a value of a raw bit based on (1) an input writeback vector comprising a main scoreboard and (2) a source vector for the oldest instruction; and
for each subsequent instruction in the queue, determining a value of a raw bit based on (1) a writeback vector from a previous instruction, wherein the writeback vector from the previous instruction is based on (i) a writeback vector input to that previous instruction and (ii) a destination vector for that previous instruction, and (2) a source vector for the subsequent instruction.

19. The method of claim 18, further comprising determining, by the vector memory scoreboard, a value of a write-after-write (waw) hazard bit for each of the plurality of instructions in the vector instruction queue, comprising:
for an oldest instruction in the queue, determining a value of a waw bit based on (1) an input writeback vector comprising a main scoreboard and (2) a destination vector for the oldest instruction; and
for each subsequent instruction in the queue, determining a value of a waw bit based on (1) a writeback vector from a previous instruction, wherein the writeback vector from the previous instruction is based on (i) a writeback vector input to that previous instruction and (ii) a destination vector for that previous instruction, and (2) a destination vector for the subsequent instruction.

20. The method of claim 18, further comprising determining, by the vector memory scoreboard, a value of a write-after-read (war) hazard bit for each of the plurality of instructions in the vector instruction queue, comprising:
for an oldest instruction in the queue, determining a value of a war bit based on (1) an initial read vector identifying any registers that will be read by one or more instructions at an issuance stage and (2) a destination vector for the oldest instruction-; and
for each subsequent instruction in the queue, determining a value of a war bit based on (1) a read vector from a previous instruction and (2) a destination vector for the subsequent instruction.
